(19) United States
(12) Patent Application Publication
(10) Pub. No.: US 2017/0120504 A1
(43) Pub. Date: May 4, 2017

(54) Sonotrode, Method for Welding a Ball, and Component Connection

(71) Applicant: Bayerische Motoren Werke Aktiengesellschaft, Muenchen (DE)

(72) Inventor: Clemens STEFANZIOSA, Muenchen (DE)

(21) Appl. No.: 15/403,236

(22) Filed: Jan. 11, 2017

Related U.S. Application Data
(63) Continuation of application No. PCT/EP2015/066758, filed on Jul. 22, 2015.

(30) Foreign Application Priority Data
Aug. 13, 2014 (DE) 10 2014 216 002.2

(51) Int. Cl. B29C 65/08; B29C 65/00; B29C 65/78

(52) U.S. Cl. CPC B29C 65/082; B29C 65/7811; B29C 65/7847; B29C 66/474; B29L 2031/30

(57) ABSTRACT

A method is provided for welding a ball to another component. The method includes: providing a sonotrode which has a trough-shaped recess, in particular a spherical cap-shaped recess; pressing the ball against the other component by the sonotrode, the ball protruding into the trough-shaped recess; and vibrating the ball by the sonotrode such that material of the ball and/or material of the other component melts, and the ball is welded to the other component.

### CROSS REFERENCE TO RELATED APPLICATIONS

This application is a continuation of PCT International Application No. PCT/EP2015/066758, filed Jul. 22, 2015, which claims priority under 35 U.S.C. §119 from German Patent Application No. 10 2014 216 002.2, filed Aug. 13, 2014, the entire disclosures of which are herein expressly incorporated by reference.

This application contains subject matter related to U.S. application Ser. No. ______, entitled “Component Connection and Method for the Plastic Forming of a Ball” filed on even date herewith.

### BACKGROUND AND SUMMARY OF THE INVENTION

The present invention relates to a sonotrode having a vibration generating device, to a method for welding a ball using the sonotrode and to a component connection formed with the ball.

From the prior art, a plurality of component connections are known, in which balls are employed as connecting elements. For example, a “component connection” is known from DE 10 2009 049 602 B3, in the case of which a ball serving as a connecting element is welded onto a body panel, which ball engages in a form-fitting manner into a recess provided in another panel.

The object of the invention is to:
a) provide a modified method for welding a ball to another component, and
b) provide a “tool” with which such a welded connection is producible, and
c) provide a corresponding component connection.

These and other objects are achieved in accordance with the embodiments of the invention.

An important aspect of the method according to the invention consists in welding a ball to another component by use of a (ultrasound) sonotrode. In the method according to the invention, a sonotrode is provided which has a trough-shaped “recess”. The “recess” can be configured, in particular, in the shape of a spherical cap. The ball is pressed against the other component by way of the sonotrode in such a manner that the ball projects into the trough-shaped recess. The trough-shaped recess thus lies against the ball from the outside comparable to a socket joint. Preferentially, the trough-shaped recess lies against the ball over a large area.

By use of the sonotrode, vibrations are induced in the ball in such a manner that material of the ball and/or material of the other component locally, i.e. in the contact region, melts and the ball is welded to the other component. By “ultrasound welding” a high-quality connection between the ball and the other component can be achieved.

The method according to the invention is suitable in particular for welding a plastic ball to another component consisting of plastic. The other component can, in particular, be a fiber-reinforced plastic component, for example a body component of a vehicle.

The plastic ball can be a ball purely consisting of a homogeneous plastic material (e.g. thermoplastic material). Alternatively, the ball can also consist of a plastic material (e.g. thermoplastic material), which is reinforced by fibers (e.g. carbon fibers, glass fibers or similar) or by particles, wherein the fibers or particles are distributed in the plastic material of the ball (e.g. thermoplastic material).

However, the ball need not necessarily consist entirely of a plastic material (e.g. thermoplastic material). In principle, the ball can consist of any material and on its entire surface or on a part region of its surface be coated with a plastic layer (e.g. thermoplastic material).

Alternatively to a plastic ball, which is welded onto a plastic component, the ball and/or the other component can also consist of another material, such as for example a metal (e.g. aluminum, copper, steel).

If the other component is a plastic component, this can be configured as a component that exclusively consists of a homogeneous plastic material (e.g. thermoplastic material). Alternatively, it can be a plastic component (e.g. made of thermoplastic material), reinforced by short, long or continuous fibers and/or by particles. Analogously to the ball, the other component can also consist of another material and be merely covered or coated entirely or at least in a part region with a layer of plastic material (e.g. thermoplastic material).

A substantial difference of the method according to the invention compared with many other ultrasound welding methods known from the prior art, in which two components are welded together by use of ultrasound, consists in that the ball used according to the invention is a component that is symmetrical in all spatial directions. Thus, the ball need not be aligned in any particular manner with respect to the other component; it is rather always aligned perfectly. If the other component is a component that is flat or substantially flat in the region of the “weld”, there is a point contact or a substantially punctiform contact between the ball and the other component before the welding, which upon introduction of ultrasound into the ball results in an extremely high energy density in the region of the contact point and thus in a neat melting of the ball and/or of the other component locally limited in the region of the contact point. This results in a high-quality symmetrical welded connection between the ball and the other component.

According to a further development of the invention, translational vibrations are induced in the ball by way of the sonotrode. The vibration direction of the ball runs through the center point of the ball and substantially perpendicularly to the point at which the ball is welded to the other component (contact or connecting point).

Alternatively or complementarily to a translational vibration movement, rotational vibrations can be induced in the ball by use of the sonotrode. In this case, the ball oscillates about an axis (torsional ultrasound vibration) running through the ball center point and the connecting point at which the ball is welded to the other component.

A substantial advantage of the invention which directly results from the complete symmetry of a ball consists in that the distance the sound has to cover, i.e. the distance between the point at which the ball is welded to the other component and the trough-shaped recess (sound introduction point), is always identical in magnitude.

While, in the case of conventional component connections produced by way of ultrasound welding, different-length sound distances and thus fluctuating welding results can occur even upon a slightly inclined position of the manual device (sonotrode), this is exactly not the case when using a ball because of its complete symmetry, which makes possible a high repetition accuracy. The method according to the invention is thus suitable in particular for large series applications. In addition, in contrast with a “cube”, no exact positioning of the other component is required since there is always a punctiform “contact situation” that is favorable for ultrasound welding.

According to a further development of the invention, a suction device is provided which is arranged on the sonotrode or integrated in the sonotrode. In principle, the suction device can also be arranged distally from the sonotrode and be fluidically connected with the sonotrode by way of at least one suction duct.

By means of such a suction device, the ball can be sucked against the trough-shaped recess or sucked into the trough-shaped recess and in the sucked-on or sucked-in state be guided against the other component by way of the sonotrode and pressed against the same.

The ball can thus be removed by suction from a “ball reservoir”, in particular from a storage container filled with a plurality of balls. When the sonotrode is guided by way of a robot, removing the ball from the ball reservoir and guiding the ball or placing the ball onto the other component can be completely automated.

For sucking-in the ball, a negative pressure duct can be provided which opens into the trough-shaped recess. By generating a negative pressure in the negative pressure duct, the ball is sucked against the trough-shaped recess or sucked into the trough-shaped recess.

A sonotrode according to the invention accordingly has a trough-shaped, in particular a spherical cap-shaped recess, which is provided in order to be placed against the ball in an areally contacting manner and in order to transmit ultrasound vibrations to the ball.

According to a further development of the invention, the trough-shaped recess has a curvature radius that is equal to the radius of the ball. In principle, the curvature radius of the trough-shaped recess however could also be smaller than the curvature radius of the ball. In this case, merely a circular contact would materialize along the edge of the trough-shaped recess between the trough-shaped recess and the ball. If the curvature radius of the trough-shaped recess is slightly larger than the curvature radius of the ball merely a slightly areal contact between the ball and the trough-shaped recess materializes.

For example, it is contemplated that balls with a diameter of 6.35 mm, i.e. with a radius of 3.175 mm are used. When the curvature radius of the trough-shaped recess is equal to the radius of the ball, the curvature radius of the trough-shaped recess is thus likewise 3.175 mm.

According to a further development of the invention, a “physical mark”, for example an “indentation” is provided on the other component in the location in which the ball is to be welded. Such a “physical mark” or indentation, which can be formed for example as a circular trough, as a punch mark, or similar, haptically makes possible exact positioning of the ball with respect to the other component and thus facilitates the placing or welding of the ball, in particular when the sonotrode is manually guided or held.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic diagram illustrating the basic principle of the welding of a ball to another component by way of an ultrasound sonotrode.

FIGS. 2A and 2B show that because of the ball geometry the distance between the sound introduction point and the contact point is identical even upon an inclined position (FIG. 2B) of the sonotrode.

### DETAILED DESCRIPTION OF THE DRAWINGS

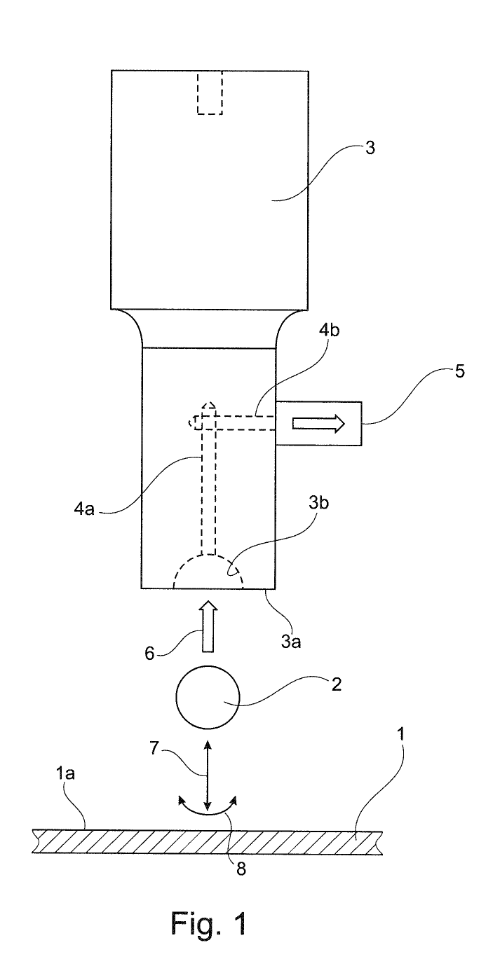

FIG. 1 shows a flat component 1, which can for example be a fiber-reinforced plastic component (e.g. a fiber-reinforced body part of a vehicle). A ball 2, which can likewise consist of a plastic material, is to be welded onto the surface la of the component 1 by use of an ultrasound sonotrode 3.

The ultrasound sonotrode, which is only shown in highly schematic form here, has, on its lower side or on its lower face end 3a, a trough-shaped or spherical cap-shaped recess 3b. In the exemplary embodiment shown in FIG. 1, the radius of the spherical cap-shaped recess 3b exactly or substantially corresponds to the radius of the ball 2.

A negative pressure duct 4a, which is fluidically connected via a negative pressure duct 4b branching off from the same to a negative pressure generating device 5 arranged on the sonotrode 3 (which is only shown in a highly schematic form here), opens into the spherical cap-shaped recess 3b. By means of the negative pressure generating device 5, a suction can be generated in the trough-shaped recess 3b via the negative pressure ducts 4a, 4b, which is indicated by an arrow 6. Through the suction, the ball 2 is sucked against the sonotrode 3 in such a manner that an upper region of the ball 2 projects into the trough-shaped recess.

In the sucked-on state, the ball 2 can be guided to the component 1 or to the surface la of the component 1 and pressed against the component 1 by moving the sonotrode, for example by use of an industrial robot. By means of a vibration generating device which is integrated in the sonotrode 3 (not shown in more detail here), translational vibrations (indicated by a double arrow 7) and/or rotational vibrations (indicated by a double arrow 8) can be induced in the ball 2. Because of this, a very high energy density is created in the contact region (substantially point contact) of the ball 2 with the surface la of the component 1, which locally limited leads to the melting of the material of the ball and/or of the material of the component 1 and thus to a welding of the ball to the component 1.

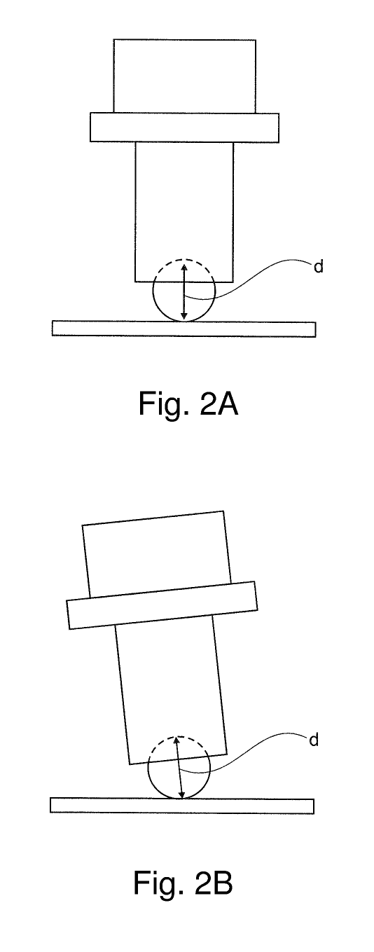

For the sake of completeness, reference is made to FIG. 2A and 2B. As is evident from a comparison of FIG. 2A and FIG. 2B, the distance d between the sound introduction point and the contact point is always identical in magnitude because of the entirely symmetrical geometry of the ball 2 even upon an inclined position of the sonotrode.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A sonotrode, comprising:
a vibration generating device, wherein
the sonotrode is provided in order to weld a ball to another component,
the sonotrode has a trough-shaped recess, which is provided in order to be placed against the ball in an areally contacting manner and in order to transmit ultrasound vibrations generated by the vibration generating device to the ball.

2. The sonotrode according to claim 1, wherein the vibration generating device is configured to generate translational vibrations.

3. The sonotrode according to claim 2, wherein the vibration generating device is configured to generate rotational vibrations.

4. The sonotrode according to claim 1, wherein the vibration generating device is configured to generate rotational vibrations.

5. The sonotrode according to claim 1, wherein the sonotrode comprises a negative pressure duct opening into the trough-shaped recess.

6. The sonotrode according to claim 4, wherein a suction device is provided by which a negative pressure for sucking on the ball is generated in the negative pressure duct.

7. The sonotrode according to claim 5, wherein the suction device is arranged in or on the sonotrode.

8. The sonotrode according to claim 1, wherein the trough-shaped recess has a curvature radius that is equal to a radius of the ball.

9. The sonotrode according to claim 7, wherein the curvature radius is approximately equal to 3.175 mm.

10. The sonotrode according to claim 1, wherein the trough-shaped recess has a spherical-cap shape.

11. A method for welding a ball to another component, the method comprising the acts of:
providing a sonotrode, which comprises a trough-shaped recess;
pressing the ball against the other component by the sonotrode, wherein the ball projects into the trough-shaped recess; and
inducing vibrations in the ball by the sonotrode in such a manner that material of the ball and/or material of the other component melts and the ball is welded to the other component.

12. The method according to claim 11, wherein translational vibrations are induced in the ball by the sonotrode.

13. The method according to claim 12, wherein rotational vibrations are induced in the ball by the sonotrode.

14. The method according to claim 11, wherein rotational vibrations are induced in the ball by the sonotrode.

15. The method according to claim 11, wherein the other component, in a place in which the ball is pressed on, is substantially or exactly flat, so that prior to welding there is a punctiform contact between the ball and the place in which the ball is pressed on.

16. The method according to claim 11, wherein the ball is sucked onto or into the trough-shaped recess by a suction device, and in the sucked-on or sucked-in state is pressed against the other component by the sonotrode.

17. The method according to claim 16, wherein the ball, through the sucking-on, is removed from a ball reservoir.

18. The method according to claim 11, wherein the ball is made of plastic material.

19. The method according to claim 18, wherein the other component is made from plastic material.

20. A component connection, comprising a ball and another component, wherein the ball is welded to the other component via ultrasound welding.
